(19) United States
(12) Patent Application Publication
(10) Pub. No.: US 2006/0163430 A1
(43) Pub. Date: Jul. 27, 2006

(54) Attendant cabin display system

(76) Inventors: Joseph L. Cordina, Parker, TX (US); Anthony B. Couzelis, Plano, TX (US)

Correspondence Address: MICHAEL L. DIAZ, P.C., 555 REPUBLIC DRIVE, SUITE 200, PIANO, TX, 75074, US

(21) Appl. No.: 11/387,657

(22) Filed: Mar. 23, 2006

Related U.S. Application Data
(63) Continuation-in-part of application No. 10/747,770, filed on Dec. 29, 2003.

(51) Int. Cl. B64D 11/00

(52) U.S. Cl. 244/118.5

(57) ABSTRACT

A system providing a graphical display of information on passengers and their baggage. The system includes a control data analysis equipment (CDAE) for compiling information from various sources. A display unit is located in the aircraft cabin and communicates with the CDAE. The system includes seat sensors which can detect when a passenger is seated in the seat, the tray table is properly stowed, and if the passenger has his seat belt fastened. Additionally, the system may optionally include an RFID system which includes a RFID tag affixed to each piece of luggage. The tag provides information on the passenger's name and other relevant information to the CDAE. The CDAE compiles all the information and provides a graphical display to the display unit.

### RELATED APPLICATIONS

This application is a continuation of a co-pending U.S. patent application Ser. No. 10/747,770 by Joseph L. Cordina and Anthony B. Couzelis entitled “ALERTING SYSTEM FOR AIRCRAFT CREW,” filed Dec. 29, 2003 which claims the priority of U.S. Pat. No. 6,676,078 (application Ser. No. 10/017,547) by Joseph L. Cordina and Anthony B. Couzelis entitled “SYSTEM AND METHOD FOR ALERTING A COCKPIT CREW OF TERRORIST ACTIVITY,” filed Dec. 14, 2001 and claims the priority date of Provisional Patent Application Serial No. 60/663,012 filed Mar. 21, 2005 and is hereby incorporated by reference herein.

### BACKGROUND OF THE INVENTION

1. Field of the Invention

This invention relates to information display systems and, more particularly, to a display system providing information to cabin and cockpit crew members.

2. Description of the Related Art

Large commercial aircraft are capable of carrying many passengers. The carriage of these passengers is problematic for flight crew, and in particular, flight attendants. Flight attendants must verify that passengers are correctly on board an aircraft (i.e., hold a ticket for the correct flight), ensure that each passenger is boarded and correctly occupying a seat. It is not uncommon for passengers to switch seat locations once the aircraft leaves a gate. This may or may not be permissible depending on the directives of each airline. However, sometimes, passengers attempt to occupy seats in first or business class when there tickets only entitle the passenger to fly in coach class. Obviously, airlines do not wish the passengers to occupy seats in higher classes without paying the higher class fares. To prevent this from happening, flight attendants must monitor the occupied seats in business and first class. However, the flight attendants only have a paper manifest which provides the passenger name and seat number. Thus, checking to see if each seat is correctly occupied is extremely difficult. At best, the flight attendant can only know at an instant how many passengers should be in each class by conducting a passenger count. Obviously, this whole process is tedious and open to mistakes.

In addition, federal regulations require that passengers are seated, securely fastened with a seat belt and tray table stowed during critical phases of flight, such as during takeoff and landing. Flight attendants must ensure that all passengers comply with these regulations. However, because of the amount of passengers, it is often time-consuming and difficult to accomplish in an expeditious manner.

Recent terrorist activities have resulted in the implementation of security measures to combat future terrorist actions. One such security measure is the positive matching of bags stowed in the cargo compartments of an aircraft with boarded passengers. If passengers are not on board, any bags associated with the unboarded passenger must be removed. At times, it is difficult to easily determine and reference a passenger that is not boarded with a bag held in a cargo compartment of the aircraft.

Thus, it would be advantageous to have a system providing a display to aircrew members of the occupancy of a passenger in a seat, if the passenger is correctly seat belted within the seat, and match the boarded passenger with his bags in the cargo compartment. It is an object of the present invention to provide such a system.

### SUMMARY OF THE INVENTION

In one aspect, the present invention is a display system which includes a control data analysis equipment (CDAE) for compiling information from various sources. A display unit is located in the aircraft cabin and communicates with the CDAE. The system includes seat sensors which can detect when a passenger is seated in the seat, the tray table is properly stowed, and if the passenger has his seat belt fastened.

In another aspect, the present invention may include an RFID system which includes a RFID tag affixed to each piece of luggage. The tag provides information on the passenger's name and other relevant information to the CDAE. The CDAE compiles all the information and provides a graphical display on the display unit.

In still another aspect, the CDAE may also include a timing mechanism to determine the amount of time a passenger continuously sits in a seat. If the passenger sits in the seat longer than a specified period of time, the CDAE provides an alert on the display unit.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a display system in the preferred embodiment of the present invention; and

FIG. 2 is a side view of the aircraft in the preferred embodiment of the present invention.

### DESCRIPTION OF THE INVENTION

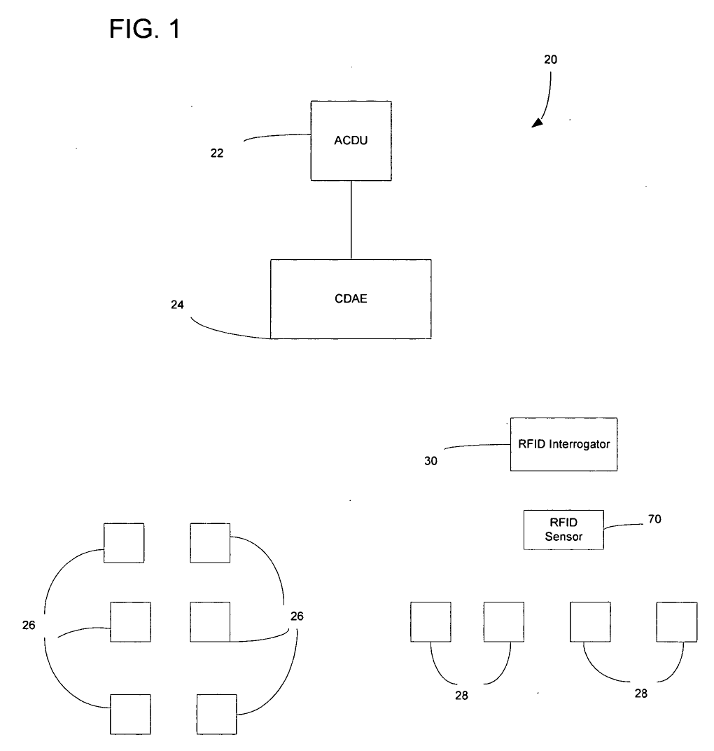

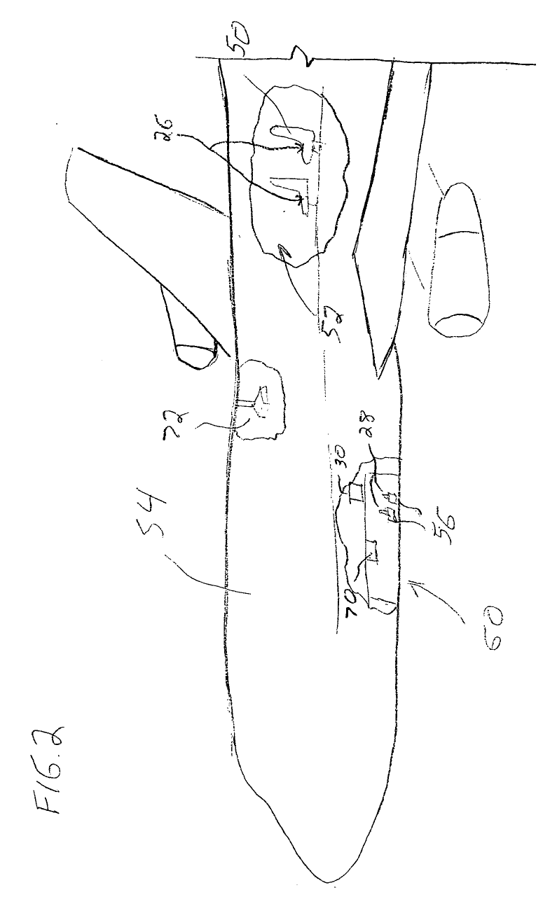

The present invention is a display system for use aboard a commercial aircraft providing information to aircrew members. FIG. 1 is a simplified block diagram illustrating the components of a display system 20 in the preferred embodiment of the present invention. The display system 20 includes a Attendant Cabin Display Unit (ACDU) 22. A central data analysis equipment (CDAE) 24 communicates with a plurality of sensors 26 located in passenger seats 50 of a cabin 52 of a aircraft 54 (see FIG. 2). Additionally, the display system includes a plurality of radio frequency identification (RFID) tags 28 attached to a plurality of passenger luggage 56. The RFID tags are tracked by an RFID tag data interrogator 30 which also communicates with the CDAE 24.

FIG. 2 is a side view of the aircraft 54 in the preferred embodiment of the present invention. The RFID tags are affixed to the luggage 56, which are stored in a cargo compartment 60 of the aircraft. An RFID tag sensor 70 located in the cargo compartment 60 detects every passenger luggage piece as it is loaded. Data contained on the RFID tag may include, the number of bags (1 of 3; 2 of 3; 3 of 3, etc.), person's ID, address, phone, destination, seat assignment by flight segment, bag weight and other relevant data as determined by the airline. This information is then passed to the CDAE 24 which stores the information and correlates the information with passengers.

The CDAE 24 also communicates with the plurality of sensors 26 which may be imbedded in the passenger seats 50 located in the cabin 52 of the aircraft 54. The sensors are able to sense pressure applied to the seats, such as when a passenger sits on the passenger seat 50 and if the seat belt is fastened about the passenger. Additionally, sensors may also be utilized to determine if the tray is in the stowed position. The sensors may also be utilized to determine if a passenger seat is in the fully upright position. The sensors may be wired and connected to the CDAE. In an alternate embodiment of the present invention, the sensors may transmit the sensed data to the CDAE 24 wirelessly. In such a case, the CDAE may communicate via an antenna sending unit (ASU) 72 which relays the information to the CDAE.

The CDAE also may receive information about the passengers (e.g., name, sex, frequent flyer card holder, checked in at gate, number of passenger luggage 56, and associated RFID tag numbers) from external sources outside of the aircraft. The CDAE may receive this information wirelessly, such as through the aircraft communication system (ACARS). The CDAE compiles all the received data from external company sources, the RFID tag data interrogator 30, and the plurality of sensors 26 and creates a graphical display which is shown on the ACDU 22.

The ACDU is preferably a LCD display located in one or more locations in the cabin 52. Preferably, the graphical display shows graphical sequentially numbered seats which are arranged in the same manner as the seats are arranged on the aircraft. For example, all rows and associated seats may be shown for ease in identifying locations of the passengers. Each seat can be shown to be reserved, occupied per the ticketing, or occupied but not ticketed, seat belt fastened, and tray table in correct stowed position. The status of the seat may be shown by colors or other symbols. For example, If a seat is reserved, the seat may be shown in green and if the seat is unassigned (unsold), the seat may disappear from the screen. Thus, in one embodiment, only pre-sold seats are illuminated. First class seats may be graphically segregated from business class seats and from coach class seats on the ACDU 22. If a seat is erroneously occupied, a red “X” (or other indicator) may be shown on the ACDU 22 to alert the flight attendant that someone is occupying the wrong seat. Additionally, this data may be cross-checked with the RFID data to determine if any checked luggage is on board for a seat that is unoccupied. This information may be important for providing a positive bag check with boarded passengers as dictated by various federal security directives. In an alternate embodiment, the ACDU provides a textual representation of information received by CDAE 24.

The ACDU provides a graphical display generated from data compiled form the CDAE 24 to provide various types of information on the passengers, passenger seats and passenger luggage. The luggage 56 of each passenger is matched with the seat assigned to a passenger. The sensors may confirm if a seat is occupied, if the seat belt is fastened and if the tray table is in the stowed position. All this information is displayed for the flight attendants' use. In turbulent situations, a seat belt sign is illuminated and flight attendants must ensure that each passenger has the seat belt fastened about them. Because the turbulence may be severe, it can be dangerous for the flight attendants to survey each seat in a safe and expeditious manner. But, the present invention enables the flight attendants to immediately see which seats are occupied, and if the seat belts are properly fastened.

The CDAE 24 may receive the information from the sensors 26 and interrogator 30 by connection directly through a wire or via wireless means. The CDAE may update this information over a specific period of time, such as every 5 seconds. This information is then continuously updated and displayed on the ACDU 22.

In an alternate embodiment, the CDAE may monitor the length of time a seat remains occupied from the time the door closes until the person rises from the seat for whatever reason. A special alert may be issued by the CDAE 24 and displayed on the ACDU 22 when a person fails to raise themselves from the seat after a pre-defined period of time. This alert is depicted on the ACDU in text form or through symbology, or both. In such an instance, the flight attendant may then alert the passenger to rise and walk around so that a case of Deep Vein Thrombosis is avoided.

The present invention provides many advantages in commercial aviation. The present invention provides a display for determining if a seat is occupied, that the seat is correctly occupied, correlating the passenger occupying the seat with checked luggage, whether the seat is in the upright position, whether the tray is stowed and whether the seat belt is fastened. All this information is graphical displayed for ease in quickly determining problems which may arise in the boarding process or to determine if a passenger is correctly and safely seated during various phases of flight.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A display system providing information on the status of an aircraft cabin, the system comprising:
a control data analysis equipment (CDAE) for compiling information;
a display unit located in the aircraft cabin and communicating with the CDAE; and
a plurality of seat sensors, each seat sensor located in a passenger seat to determine if a seat is occupied by a passenger;
each seat sensor sensing if a seat is occupied and sending the information about the occupancy of the seat to the CDAE;
whereby the CDAE compiles the received seat information and provides a graphical display of the compiled information on the display unit.

2. The display system of claim 1 further comprising a plurality of tray sensors for sensing if a tray is in a stowed position, each tray sensor sending information on a position of the tray to the CDAE;
whereby the CDAE compiles the received tray information and provides a graphical display of the compiled information on the display unit.

3. The display system of claim 1 further comprising a plurality of seat position sensor for sensing if a seat is in a fully upright position, each seat position sensor sending information on a position of the seat to the CDAE;
whereby the CDAE compiles the received seat position information and provides a graphical display of the compiled information on the display unit.

4. The display system of claim 1 further comprising a plurality of seatbelt sensors for sensing if a seatbelt is fastened, each seatbelt sensor sending information on if a seatbelt is fastened to the CDAE;
whereby the CDAE compiles the received seat position information and provides a graphical display of the compiled information on the display unit.

5. The display system of claim 1 wherein the CDAE receives information about passengers and a ticketed location of each passenger, whereby the CDAE compiles the passenger information and graphically displays each seat ticketed with a passenger.

6. The display system of claim 1 wherein the plurality of seat sensors are in wireless communication with the CDAE.

7. The display system of claim 1 further comprising a radio frequency identification (RFID) system, the RFID system including a plurality of RFID tags affixed to passenger luggage carried by the aircraft;
the RFID system detecting the RFID tags and sending luggage information to the CDAE;
whereby the CDAE receives the luggage information, correlates the luggage information with boarded passengers and graphically presents information on boarded passenger with the detected luggage on the display unit.

8. The display system of claim 7 wherein the RFID tags includes information on a passenger associated with each piece of luggage, the RFID system sending the passenger information to the CDAE.

9. The display system of claim 1 wherein the CDAE times the amount of time each seat sensor detects a passenger sitting in the seat, the CDAE providing a graphical representation on the display unit of the length of time each passenger continuously sits in the seat.

10. The display system of claim 9 wherein the CDAE provides an alert on the display unit when a passenger continuously sits in the seat beyond a specified period of time.

11. The display system of claim 1 wherein the display unit provides a graphical representation when an unreserved seat is occupied.

12. The display system of claim 1 wherein the display unit provides a graphical representation when the CDAE determines that luggage is boarded on the aircraft and an associated passenger of the luggage has not boarded the aircraft.

13. The display system of claim 1 wherein the CDAE generates a graphical display on the display unit when a passenger is not seat belted and the seat does not have a tray table stowed.

14. A display system to monitor the status of an aircraft cabin, the system comprising:
a control data analysis equipment (CDAE) for compiling information;
a display unit located in the aircraft cabin and communicating with the CDAE; and
means for determining if a seat is occupied and sending occupancy information to the CDAE;
whereby the CDAE compiles the received seat information and provides a graphical display of the compiled information on the display unit.

15. The display system of claim 14 further comprising a means for determining if each tray table at each seat is stowed and sending the tray table information to the CDAE, the CDAE compiling the received information on the display unit.

16. The display system of claim 14 further comprising a radio frequency identification (RFID) system, the RFID system including a plurality of RFID tags affixed to passenger luggage carried by the aircraft;
the RFID system detecting the RFID tags and sending luggage information to the CDAE;
whereby the CDAE receives the luggage information, correlates the luggage information with boarded passengers and graphically presents information on boarded passenger with the detected luggage on the display unit.

17. A display system to monitor the status of an aircraft cabin, the system comprising:
a control data analysis equipment (CDAE) for compiling information;
a display unit located in the aircraft cabin and communicating with the CDAE; and
a plurality of seat sensors, each seat sensor located in a passenger seat to determine if a seat is occupied by a passenger, each seat sensor sensing if a seat is occupied and sending the information about the occupancy of the seat to the CDAE;
a plurality of seatbelt sensors for sensing if a seatbelt is fastened, each seatbelt sensor sending information on if a seatbelt is fastened to the CDAE;
a plurality of tray sensors for sensing if a tray is in a stowed position, each tray sensor sending information on a position of the tray to the CDAE;
whereby the CDAE compiles the received information and provides a graphical display of the compiled information on the display unit.

18. The display system of claim 17 further comprising a radio frequency identification (RFID) system, the RFID system including a plurality of RFID tags affixed to passenger luggage carried by the aircraft;
the RFID system detecting the RFID tags and sending luggage information to the CDAE;
whereby the CDAE receives the luggage information, correlates the luggage information with boarded passengers and graphically presents information on boarded passenger with the detected luggage on the display unit.
